(19) United States
(12) Patent Application Publication
(10) Pub. No.: US 2021/0047544 A1
(43) Pub. Date: Feb. 18, 2021

(54) TAPE WITH MULTIPLE PULL TAB GRIPS

(71) Applicant: Ernest Schwartz, Brooklyn, NY (US)

(72) Inventor: Ernest Schwartz, Brooklyn, NY (US)

(21) Appl. No.: 16/866,459

(22) Filed: May 4, 2020

Related U.S. Application Data
(63) Continuation-in-part of application No. 16/686,926, filed on Nov. 18, 2019, now abandoned.
Application No. 16/686,926 is a continuation of application No. 16/369,345, filed on Mar. 29, 2019, now abandoned.
(60) Provisional application No. 62/649,712, filed on Mar. 29, 2018.

(51) Int. Cl. C09J 7/40

(52) U.S. Cl. CPC C09J 7/403; C09J 2301/18

(57) ABSTRACT

Generally, the present invention comprises a tape roll with multiple pull tabs being integrated with the roll at selected length positions, such as at 6 to 8 inch intervals or any length commonly used for particular applications. In a preferred embodiment, in a tape roll, a selected portion of tape has an initial tab grip segment fixedly integrated to a selected length tape strip and the opposing end is perforated or notched to facilitate tearing off of the selected segment. Thereafter, another tab is exposed and another segment of predetermined size may be easily lifted off and cut.

### FIELD OF THE INVENTION

This invention relates to finger grip or pull tabs for adhesive tapes and relates particularly to adhesive tapes commonly used in specific sized segments and those not used in dispensers.

### BACKGROUND

Adhesive tapes range in nature from the commonly used “Scotch Tape” (registered trademark of the 3M Company) or similar mending tapes, packing tapes, duct tapes, masking tapes and the like. A common feature with nearly all of these tapes is that they are strips of usually plastic materials configured in the shape of wound rolls and (except for double sided tapes) have one adhesive side and a non-adhesive side. In the roll configuration the non-adhesive side is adhered to the adhesive side in a compact and stably configured shape. In use, an end of the tape on an outermost end position of the roll is lifted to effect a separation between the adhesive side of the tape and the non-adhesive side of the tape and an appropriate length is selected and pulled from the roll and the tape is cut or torn at the selected length. To initially assist in this procedure, the free end of the tape is often provided with a non-adhesive pull tab. For subsequent use of the tape, tapes are often placed in dispensers wherein the free cut end of the tape is positioned on a flat portion of the dispenser adjacent a cutting edge for ready lifting and repetitions of the initial tape size selection, cutting to size and removal.

An irritating problem often occurs with tapes which are not used in a dispenser or even with tapes used in a dispenser but wherein the free end of the tape is not adhesively engaged with the flat end cutting position. The free end of the tape often falls on an adjacent non-adhesive surface of the tape in the roll and it becomes difficult to cleanly lift the free end of the tape to effect another tape length selection. It often becomes necessary to scratch the free end off the adjacent tape by means of fingernails or a knife edge.

### SUMMARY OF THE INVENTION

Generally the invention comprises a roll of adhesive tape having adhesive and a non-adhesive obverse surfaces having a series of sequential preformed pull tabs positioned on the non-adhesive surface. The pull tabs are spaced from each other by a predetermined length. A portion of the adhesive tape adjacent each pull tab and parallel thereto, i.e. across a width of the tape is weakened whereby a section of tape is severed at the weakened portion with a lifting and pulling on a prior positioned pull tab, With severing of the tape at the weakened portion, the adjacent pull tab acquires a free end to permit the adjacent pull tab to sequentially operate as a pull tab for lifting and pulling of a next length of tape and severing of a next sequential weakened portion.

Embodiments of the present invention comprises a tape roll with multiple pull tabs being integrated with the roll at selected length positions, such as at 6 to 8 inch intervals or any length commonly used for particular applications. In a preferred embodiment, in a tape roll, a selected portion of tape has an initial tab grip segment fixedly integrated to a selected length tape strip and the opposing end is perforated or notched to facilitate tearing off of the selected segment. Thereafter, another tab is exposed and another segment of predetermined size may be easily lifted off and cut.

Positioning of the tabs in a manufacturing process may be effected in various manners. In one embodiment an extended tape strip, prior to rolling is pinched at selected interval with adjacent small segments of the tape being adhered to each other to provide a lift tab. A half inch tape segment, when pinched to effect adhesive to adhesive bonding, provides a quarter inch tab sufficient for most applications. Tape grip elements of varying sizes may be simply provided thereby by adjusting the size of the pinched area. The process is repeated throughout the tape length prior to or at the same time as rolling of the strip into a dispensing roll. Except for the first tab which may simply be a non-adhesive tab end, the remainder of the roll strip is provided with the tab elements at the pre-selected intervals. It is preferred that prior to each tab, the strip is perforated or notched to facilitate tape tearing at the point at which the new tab is exposed for subsequent use.

Other manufacturing methods are possible such as with the adhering of separate tab elements to the non-adhesive surface of the adhesive strip at preselected length intervals with a bonding of greater strength than that between the adhesive-non-adhesive interface in the tape roll whereby the pull tabs may be utilized without being pulled off the tape roll. Perforations or notching may be effected simultaneously therewith, as described above, as desired.

Another, embodiment comprises providing a tape strip prior to rolling with spaced apart segments without adhesive thereon or with an adhered stiffening element such as plastic, cardboard and the like adhered to a section of adhesive of the tape which blocks adhesion to other surfaces and which can function as a pull tab. Except for an initial end segment, the non-adhesive tape segment or pull tab is directly preceded by a tape perforation or notch whereby a preceding tape segment is detachable from the tape roll and the subsequent tab is easily available for manual or finger manipulation. The perforations are sized to maintain tensile connection should different size or longer segments be desired or required but permit ready lateral tearing when a selected size is reached at the perforation site.

In addition to use in aiding in the removal of tape segments from a roll by providing constant pull tab segments, the tab segment may be allowed to unobtrusively extend from a taped box or other container to provide an integral pull tab for ready removal of tape from a sealed box or other container. Accordingly, applications for the tape with multiple tabs of the invention are applicable to tape use both manually and with application machines and devices.

Objects, features and advantages of the invention will become more evident from the following discussion and drawings in which:

### SHORT DESCRIPTION OF THE DRAWINGS

FIG. 1 depicts an adhesive strip with pinched tab formation and perforation at selected length intervals prior to tape rolling into a roll;

FIG. 2 depicts the adhesive strip of FIG. 1 but with separate adhering placement of a separate pull tab at selected length intervals prior to rolling of the tape into a roll;

FIG. 3 depicts the adhesive strip of FIG. 1 but with integral segments of non-adherent tape (or with non-adherent tab segments) with adjacent perforations;

FIG. 4 shows a rolled tape with any of the pull tab embodiments of FIGS. 1-3, and

FIG. 5 shows a residual tab on a packing box which extends for ready removal of the tape from the box.

### DETAILED DESCRIPTION

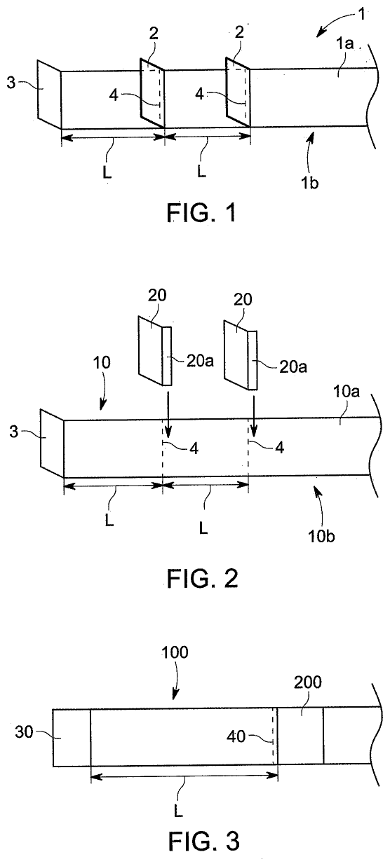

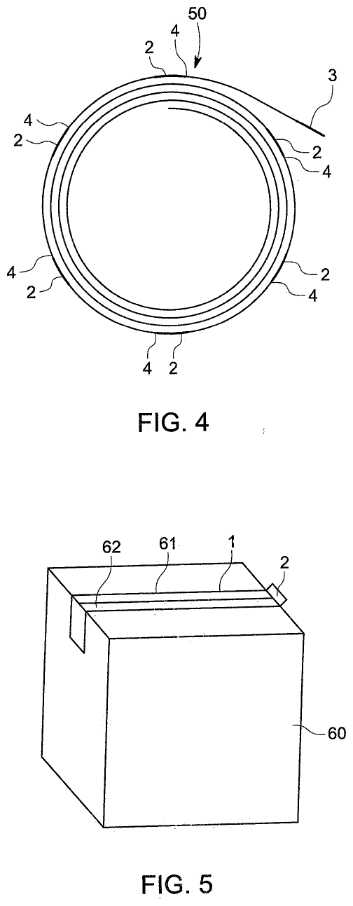

With reference to the drawings, an initial segment 1 of a tape roll, with non-adhesive side 1a and adhesive obverse side 1b, is shown with a starting non adhesive paper pull tab 3. Small sections 2 are shown at measured intervals L and are each comprised of a section of the tape having been pinched, with adhesive areas being adhered to each other to form the section 2. Each section 2 extends away from the non adhesive side 1a to effectively provide pull tabs at pre-determined intervals. Perforated sections 4 are positioned to be torn with selection of removed tape lengths and with freeing up of the respective tape tab sections 2 as the tap roll is used. FIG. 4 shows a tape roll 50 with the tape tab configuration shown in FIG. 1 with spaced apart tape tab sections 2.

FIG. 2 shows an alternative embodiment relative to that of FIG. 1, with separate tab elements 20 being adhered to the tape segment 10 at the L length intervals, with adhering sections 2a. The adhesive connective the adhering sections 2a with the tape segment 10a is of stronger adhering strength than that of the tape adhesive on surface 10b with the respective tab elements 20 being able to lift the end of tape sections at L length intervals after tear perforation 4.

FIG. 3 shows a third embodiment wherein the tape 100 is provided with sections 200 having no adhesive surface on either surface, with each section 200 functioning in a manner similar to that of initial lift tab 3a, after tearing of the adjacent perforation at 4, to provide an unadhered section end,

FIG. 5 depicts carton 60 being sealed with tape 1 of FIG. 1 along aligned flaps 61. Pull tab 2 remains on the package and is available as a pull tab to remove the tape from the carton to open it.

It is understood that the above description and figures are illustrative of the invention and that changes may be made in the formation, structure, and configuration of the pull tapes of the invention without departing from the scope of the invention as defined in the following claims.

What is claimed is:

1. A roll of adhesive tape having adhesive and a non-adhesive obverse surfaces and having a series of sequential preformed pull tabs positioned on the non-adhesive surface and spaced from each other by a predetermined length and wherein a portion of the adhesive tape adjacent each pull tab and parallel thereto is weakened whereby a section of tape is severed at the weakened portion with a lifting and pulling on a prior positioned pull tab and wherein the adjacent pull tab acquires a free end to permit the adjacent pull tab to sequentially operate as a pull tab for lifting and pulling of a next length of tape and severing of a next sequential weakened portion.

2. The roll of adhesive tape of claim 1, wherein the weakened portion is comprised of a perforation of the tape extending across a width of the tape.

3. The roll of adhesive tape of claim 1, wherein the preformed pull tabs are comprised of pinched together adjacent sections of the tape with adhesive to adhesive bonding of the adjacent sections.

4. The roll of adhesive tape of claim 1, wherein the preformed pull tabs are separate element adhered at a base thereof to the roll of adhesive tape with an adhesive have adhesive strength greater than the adhesive of the adhesive tape.

5. The roll of adhesive tape of claim 1, wherein the preformed pull tabs comprise sections of the adhesive tape which are free of any adhesive.
